(19) United States
(12) Patent Application Publication
(10) Pub. No.: US 2025/0028784 A1
(43) Pub. Date: Jan. 23, 2025

(54) FOURIER DOT PRODUCT ANALOG MATRIX MULTIPLIER DEVICE

(71) Applicant: Worcester Polytechnic Institute, Worcester, MA (US)

(72) Inventors: Jack Adiletta, Bolton, MA (US); Ukluhan Guler, Northborough, MA (US)

(73) Assignee: Worcester Polytechnic Institute, Worcester, MA (US)

(21) Appl. No.: 18/777,818

(22) Filed: Jul. 19, 2024

Related U.S. Application Data
(60) Provisional application No. 63/527,679, filed on Jul. 19, 2023.

(51) Int. Cl. G06F 17/16

(52) U.S. Cl. CPC G06F 17/16

(57) ABSTRACT

Embodiments of the present innovation relate to a Fourier dot product analog matrix multiplier device. In one arrangement, the analog matrix multiplier device is configured as a set of analog transistor circuits and can include a set of signal generators and a Fourier dot product circuit. The components of the analog matrix multiplier device are configured to perform a Fourier dot product multiplication process relative to coefficients received by the analog matrix multiplier device. The Fourier dot product analog matrix multiplier device leverages the low power capabilities of analog circuits and a mathematical algorithm to reduce the number of components and power required to perform matrix multiplication.

### RELATED APPLICATIONS

This patent application claims the benefit of U.S. Provisional Application No. 63/527,679, filed on Jul. 19, 2023, entitled “Fourier Dot Product Analog Multiplier Device,” the contents and teachings of which are hereby incorporated by reference in their entirety.

### BACKGROUND

A growing field in semiconductors is computational accelerator devices: application specific integrated circuits (ASICS) that assist a CPU with a given task. Accelerators are necessary because making transistors smaller is becoming increasingly challenging and costly. Particular accelerators, such as Artificial Intelligent (AI) accelerators, have been designed to efficiently process AI workloads, such as neural networks.

During operation, AI accelerators utilize matrix multiplication when performing AI computations, such as during speech and image recognition processing. Large language models such as Chat GPT (OpenAI, San Francisco, CA), LLAMA (Meta AI, New York, NY) and Gemini (Google AI, San Francisco, CA) require AI accelerators to perform a relatively large number of matrix multiplication during operation. For example, during processing of Chat GPT, it is estimated that 85% of an accelerator's computation of is dedicated to matrix multiplication. Further, conventional graphics processing units (GPUs) include, as a machine learning accelerator, a General Matrix Multiplier (GeMM) that performs matrix multiplication.

### SUMMARY

Conventional machine learning and AI accelerators suffer from a variety of deficiencies. For example, conventional artificial intelligence (AI) and machine learning (ML) accelerator devices are power intensive, particularly with respect to the performance of matrix multiplication by accelerators requires a relatively large amount of power. It is estimated that it takes approximately 1.287 Gigawatt hours for an accelerator to train ChatGPT 3.5. As the learning language models grow in size, the power required by these accelerators to train the models is expected to increase. Further, in order to perform matrix multiplication, conventional accelerators, such as GeMMs, require hundreds of thousands and up to millions of transistors to perform matrix multiplication. As machine leaning models become more complex, the number of components required by machine learning accelerators to process the model will increase, thereby increasing the size, complexity, and cost of these accelerators.

By contrast to conventional accelerator devices, embodiments of the present innovation relate to a Fourier dot product analog matrix multiplier device. In one arrangement, the analog matrix multiplier device is configured as a set of analog transistor circuits and can include a set of signal generators such as a set of sine wave oscillators and a Fourier dot product circuit that can include an assembler stage having a set of frequency modulators and summation amplifiers and a multiplier stage having an analog multiplier circuit and an integration amplifier. In the case where the analog matrix multiplier device is employed in a digital domain, the analog matrix multiplier device can receive input through a digital to analog data converter and can provide an output through an analog to digital data converter. In the case where the analog matrix multiplier device is employed in an analog domain, such as an embedded AI use, the analog matrix multiplier device can receive an analog input and provide an analog output.

The components of the analog matrix multiplier device are configured to perform a Fourier dot product multiplication process relative to coefficients received by the analog matrix multiplier device. For example, the Fourier pot product multiplication process utilizes the Fourier decomposition of two similarly modulated sine series, where each series element coefficient is the respective matrix weight, are multiplied then integrated a matrix “dot product” is performed. This multiplication process reduces an N×M matrix multiplied with an M×K matrix from N×M×K operations to N×K operations. This significantly reduces computation required, especially if M is very large, which in generative transform AI models (e.g., ChatGPT) is very large.

The Fourier dot product analog matrix multiplier device leverages the low power capabilities of analog circuits and a mathematical algorithm to reduce the number of components and power required to perform a dot product multiplication. For example, the design of the Fourier dot product analog matrix multiplier device includes on the order of thousands of transistors versus on the order of millions of transistors found in conventional accelerators. As such, the analog matrix multiplier device costs relatively less to manufacture, is more compact, and operates relatively faster, than conventional accelerator devices.

Additionally, because dot products are the basis for a vast number of AI and machine learning (ML) processes, the Fourier dot product analog matrix multiplier device can reduce the time utilized to train an AI or ML model. With growth of the AI/ML marketplace, the Fourier dot product analog matrix multiplier device can supplant the GeMM engine in conventional GPUs as the primary AI/ML computation engine for training, while significantly reducing both cost and power and improving performance.

In one arrangement, embodiments of the innovation relate to an analog matrix multiplier device, comprising: a set of digital-to-analog converters configured to: receive a first vector having matrix row value coefficients, receive a second vector having matrix column value coefficients, and convert each of the row value coefficients of the first vector from a digital domain to an analog domain and to convert each of the column value coefficients of the second vector from the digital domain to the analog domain; a set of signal generators, each signal generator of the set of signal generators configured to generate a wave signal at a given integer frequency; a Fourier dot product circuit disposed in electrical communication with the set of digital-to-analog converters and the set of signal generators, the Fourier dot product circuit configured to perform a Fourier dot product multiplication process relative to the row value coefficients of the first vector, the column value coefficients of the second vector, and corresponding wave signals at given integer frequencies to generate a Fourier dot product; and an analog-to-digital converter disposed in electrical communication with the Fourier dot product circuit, the analog-to-digital converter configured to convert the Fourier dot product from the analog domain to the digital domain and to output the Fourier dot product in the digital domain.

In an analog matrix multiplier device, a method for generating a Fourier dot product, comprising: receiving, by a set of digital-to-analog converters of the analog matrix multiplier device, a first vector having matrix row value coefficients; receiving, by the set of digital-to-analog converters of the analog matrix multiplier device, a second vector having matrix column value coefficients; converting, by the set of digital-to-analog converters of the analog matrix multiplier device, each of the row value coefficients of the first vector from a digital domain to an analog domain and to convert each of the column value coefficients of the second vector from the digital domain to the analog domain; generating, by each signal generator of a set of signal generators of the analog matrix multiplier device, a wave signal at a given integer frequency; performing, by a Fourier dot product circuit of the analog matrix multiplier device, a Fourier dot product multiplication process relative to the row value coefficients of the first vector, the column value coefficients of the second vector, and corresponding wave signals at given integer frequencies to generate a Fourier dot product; and converting, by an analog-to-digital converter of the analog matrix multiplier device, the Fourier dot product from the analog domain to the digital domain and outputting the Fourier dot product in the digital domain.

An analog matrix multiplier device, comprising: a set of signal generators, each signal generator of the set of signal generators configured to generate a wave signal at a given integer frequency; a Fourier dot product circuit disposed in electrical communication with the set of signal generators, the Fourier dot product circuit configured to: receive a first vector having matrix row value coefficients in an analog domain, receive a second vector having matrix column value coefficients in the analog domain, perform a Fourier dot product multiplication process relative to the row value coefficients of the first vector, the column value coefficients of the second vector, and corresponding wave signals at given integer frequencies to generate a Fourier dot product, and output the Fourier dot product in the analog domain.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a schematic depiction of a Fourier dot product analog matrix multiplier system, according to one arrangement.

FIG. 2 illustrates a Fourier dot product multiplication algorithm performed by the Fourier dot product analog matrix multiplier device of FIG. 1, according to one arrangement.

FIG. 3 illustrates a schematic depiction of the Fourier dot product analog matrix multiplier device of FIG. 1, according to one arrangement.

FIG. 4 is a flowchart that illustrates a process performed the matrix multiplier device of FIG. 1 when generating a Fourier dot product.

FIG. 5 illustrates a schematic depiction of the Fourier dot product analog matrix multiplier system, according to one arrangement.

### DETAILED DESCRIPTION

By contrast to conventional accelerator devices, embodiments of the present innovation relate to a Fourier dot product analog matrix multiplier device. In one arrangement, the analog matrix multiplier device is configured as a set of analog transistor circuits and can include a set of signal generators such as a set of sinusoidal wave oscillators and a Fourier dot product circuit that can include an assembler stage having a set of frequency modulators and summation amplifiers and a multiplier stage having an analog multiplier circuit and an integration amplifier. In the case where the analog matrix multiplier device is employed in a digital domain, the analog matrix multiplier device can receive input through a digital to analog data converter and can provide an output through an analog to digital data converter. In the case where the analog matrix multiplier device is employed in an analog domain, such as an embedded AI use, the analog matrix multiplier device can receive an analog input and provide an analog output.

The components of the analog matrix multiplier device are configured to perform a Fourier dot product multiplication process relative to coefficients received by the analog matrix multiplier device. For example, the Fourier pot product multiplication process utilizes the Fourier decomposition of two similarly modulated sine series, where each series element coefficient is the respective matrix weight, are multiplied then integrated a matrix “dot product” is performed. This multiplication process reduces an N×M matrix multiplied with an M×K matrix from N×M×K operations to N×K operations. This significantly reduces computation required, especially if M is very large, which in generative transform AI models (e.g., ChatGPT) is very large.

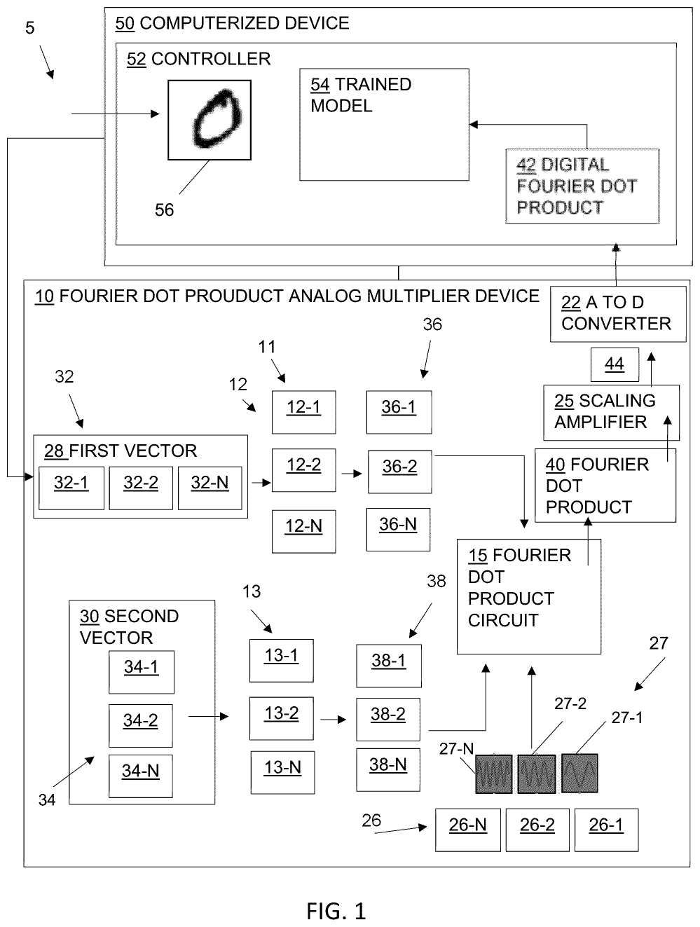

FIG. 1 illustrates a schematic representation of a Fourier dot product analog matrix multiplier system 5, according to one arrangement. The system 5 can include a computerized device 50 disposed in electrical communication with one or more Fourier dot product analog matrix multiplier devices 10.

The computerized device 50 can be a server device having a controller 52, such as a processor and memory. In one arrangement, the computerized device 50 is configured to generate and execute a trained model 54 based upon the type of service associated with the computerized device 50. For example, controller 52 is configured to execute a model 54 that is trained to is classify a digital representation of a handwritten number 56, such as provided as a digital input from a digital writing device, as an integer having a value between 0-9. Further, the controller 52 can be configured to update the trained model 54, such as based upon feedback provided by the Fourier dot product analog matrix multiplier device 10.

The Fourier dot product analog matrix multiplier device 10 is configured to work in conjunction with the computerized device 50 to perform matrix multiplication tasks during execution of the trained model 54. In one arrangement, the analog matrix multiplier device 10 is configured to receive digital coefficients 32 from a computerized device 50 as a first vector 28 via a first set of digital to analog to data converter 12 and to provide a digital Fourier dot product 42 as output in the digital domain via the analog to digital converter 22.

As illustrated, the analog matrix multiplier device 10 includes a set of digital to analog converters 11, an analog to digital converter 22, and a set of wave generators 26, each disposed in electrical communication with a Fourier dot product circuit 15.

During operation, the analog matrix multiplier device 10 receives an input vector row as a first vector 28 from the computerize device 50 and a weight matrix configured as an input vector column (i.e., a second vector) having respective elements or coefficients 32, 34 configured in the digital domain. The set of digital to analog converters 11 is configured to convert each of the vector coefficients 32, 34 from the digital domain to an analog domain for processing by the analog Fourier dot product circuit 15. For example, the set of digital to analog converters 11 includes a first set of digital-to-analog converters 12 where each converter 12-1 to 12-N receives a corresponding row value coefficients 32-1 to 32-N of the first vector 28 and converts the row value coefficients 32-1 to 32-N to a set of corresponding analog row value coefficients 36 (e.g., voltage values). Further, the set of digital to analog converters 11 includes a second set of digital-to-analog converters 13 where each converter 13-1 to 13-N receives a corresponding column value coefficients 34-1 to 34-N of the second vector 30 and converts the column value coefficients 34-1 to 34-N to a set of corresponding analog column value coefficients 38. As such, each digital to analog converter of the set of digital to analog converters 11 converts a single, corresponding row coefficient 32 or column coefficient 34 from the digital domain to the analog domain.

The set of wave generators 26 are configured to generate wave signals 27 at a given integer frequency. For example, each wave generator of the set of frequency modulators 14 can be a sinusoidal wave oscillator configured to generate sine waves or cosine waves at particular integer frequencies. In one arrangement, the number of wave generators 26 carried by the analog matrix multiplier device 10 corresponds to the number of row value coefficients 32-1 to 32-N of the first vector 28 and column value coefficients 34-1 to 34-N of the second vector 30. As such, each wave generator 26 is configured to generate an integer frequency relating to a corresponding coefficient of each of the first and second vectors 28, 30.

As provided above, conventional accelerators utilize matrix multiplication when executing AI and ML models. Matrix multiplication is performed by computing the dot product of the rows in one matrix with the corresponding columns in a second matrix. For example, dot products between N element rows/columns require N multiplications. As such, the utilization of such matrix multiplication by conventional accelerators during the performance of AI or ML computations is relatively power intensive.

By contrast to conventional accelerators, the Fourier dot product device 15 is an analog circuit configured to perform matrix multiplication based upon the principles of dot product multiplication using a Fourier series. For example, the Fourier dot product device 15 is configured to use a wave series, such as a sine series, to perform dot product multiplication. A Fourier Series is defined as a sum of sine and cosine sub-waves with frequencies that are integer multiples. That is, any complex wave can be broken down into cosine waves and sine waves. Traditionally, the Fourier Series encodes a periodic signal as a series of sub-waves. Each sub-wave coefficient is found by multiplying the periodic signal by a sine or cosine sub-wave of the same frequency and integrating. Rather than encoding a periodic signal, the Fourier dot product device 15 is configured to perform dot product multiplication using two sine series.

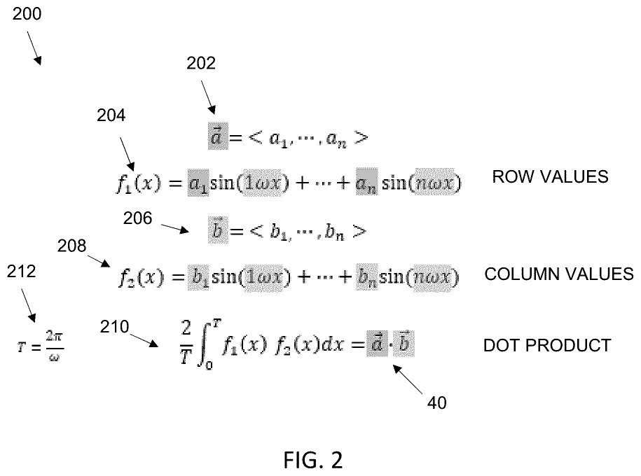

In one arrangement, FIG. 2 illustrates a Fourier dot product multiplication algorithm 200 executed by the Fourier dot product device 15. As shown, the values of vectors a\vec{ } 202 and b\vec{ } 204 are the coefficients to the first and second sine series of functions 206, 208, respectively. For example, the Fourier dot product device 15 can apply the values of vector a\vec{ } 202 to sine wave components of corresponding frequencies. Accordingly, a₁ corresponds to frequency 1 of the first sine series 206 and an corresponds to frequency n of the first sine series 206. As such, the first function 206 encodes vector a\vec{ } 202 as a sine series. Further, the Fourier dot product device 15 can apply the values of vector b\vec{ } 204 to sine wave components of corresponding frequencies. Accordingly, b₁ corresponds to frequency 1 of the second sine series 208 and bₙ corresponds to frequency n of the second sine series 208. As such, the second function 206 encodes vector a\vec{ } 202 as a sine series. It is noted that while the values of vectors a\vec{ } 202 and b\vec{ } 204 are the coefficients to the first and second sine series of functions 206, 208, the vectors a\vec{ } 202 and b\vec{ } 204 can alternately be applied as the coefficients of first and second cosine series of functions as well.

Next, with continued reference to FIG. 2, when executing the Fourier dot product multiplication algorithm 200, the Fourier dot product device 15 multiplies the first function 206 and the second function 208 and integrates the product to generate the dot product 40 of vector a\vec{ } and vector b\vec{ }. Further, the Fourier dot product device 15 can scale the dot product 40 by a factor of by 2/T where T=(2*pi)/omega 212. The value of omega controls the speed of the Fourier dot product multiplication such that a relatively low omega leads to a relatively lower processing speed and relatively lower power draw while a relatively higher omega leads to a relatively higher processing speed and relatively higher power draw.

As provided above, with conventional accelerators, dot products between N element rows/columns require N multiplications. Accordingly, in the case where vector a and vector b each include 100 values, a conventional accelerator will need to multiply a1*b1, a2*b2, . . . , a100*b100 then add each product together—a total of 100 multiplication processes and 99 addition processes. By contrast, the Fourier dot product device 15 utilizes analog circuitry to perform a single multiplication process and a single integration process.

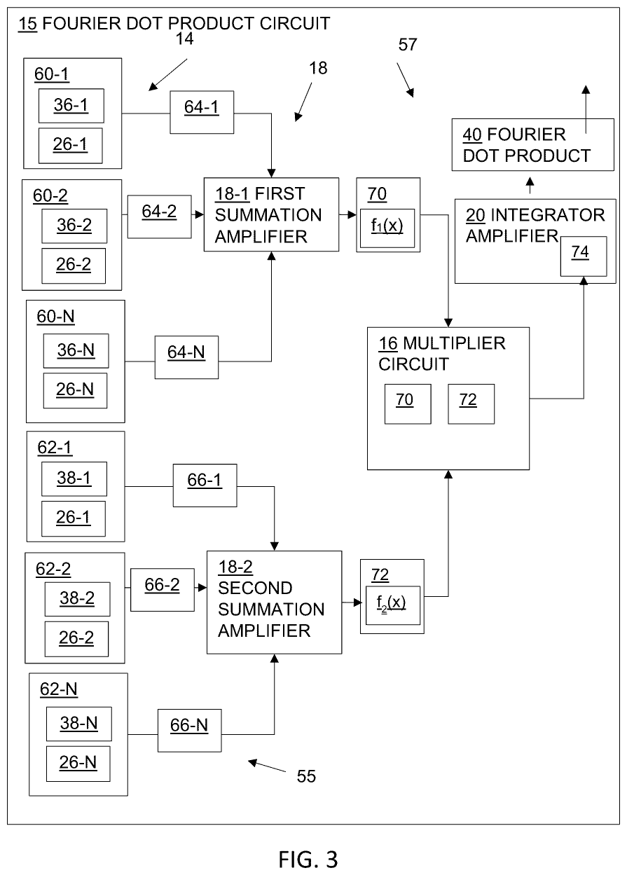

Returning to FIG. 1, the Fourier dot product circuit 15 can be configured in a variety of ways. For example, with reference to FIG. 3 the Fourier dot product device 15 can include an assembler stage 55 having a set of frequency modulators 14, such as including positive-edge-triggered flip flops, disposed in electrical connection with summation amplifiers 18. The Fourier dot product device 15 can further include and a multiplier stage 57 disposed in electrical connection with the assembler stage 55 and having a multiplier circuit 16, such as a MOSFET-based Gilbert cell, disposed in electrical connection with an integration amplifier 20. Each of the set of frequency modulators 14, summation amplifiers 18, multiplier circuit 16, and integration amplifier 20 are configured as analog circuit components. For example, each of the frequency modulators 14, summation amplifiers 18, multiplier circuit 16, and integration amplifier 20 can be configured as discrete circuit components, such as individual integrated circuit components. In another example, each of the frequency modulators 14, summation amplifiers 18, multiplier circuit 16, and integration amplifier 20 can be configured as a single circuit component, such as part of a single integrated circuit.

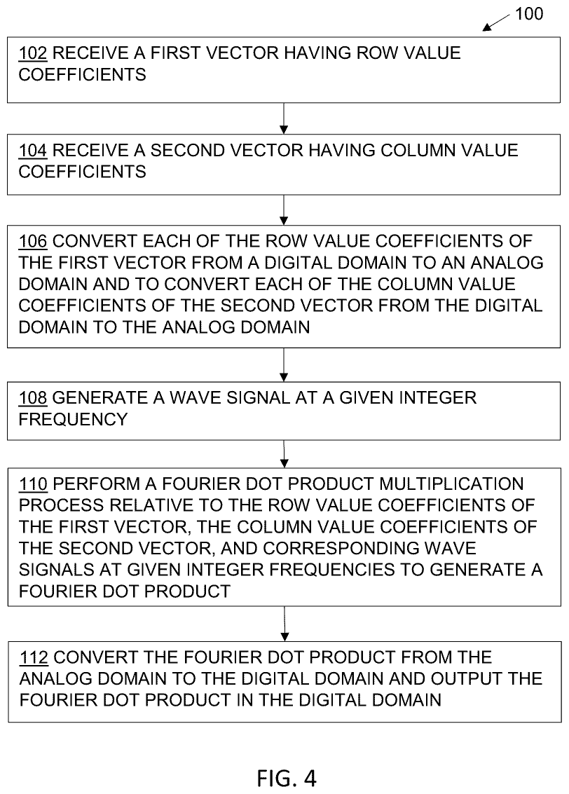

As indicated above, the Fourier dot product analog matrix multiplier device 10 is configured to perform matrix multiplication tasks, such in conjunction with the execution of the trained model 54 by the computerized device 50. FIG. 4 is a flowchart 100 that illustrates a process performed the matrix multiplier device 10 of FIG. 1 when generating a Fourier dot product 40.

In element 102, the set of digital-to-analog converters 11 of the analog matrix multiplier device 10 are configured to receive a first vector 28 having matrix row value coefficients 32. For example, with reference to FIG. 1, during operation the computerized device 50 can receive an input, such as a digital representation of a handwritten number 56 and can execute the trained model 54 to classify the digital representation of the handwritten number 56 as an integer having a value between 0-9. In response, the computerized device 50 can provide the digital input to the analog matrix multiplier device 10 as a first vector 28 having matrix row value coefficients 32-1 through 32-N. For example, in the case here the input is a 28×28 pixel image of a handwritten number, the computerized device 50 can provide the first vector 28 as a vector having 784 row value coefficients representing the pixel values of the digital representation of the handwritten number 56.

Returning to FIG. 4, in element 104, the set of digital-to-analog converters 11 of the analog matrix multiplier device 15 are configured to receive a second vector 30 having matrix column value coefficients. 34. In one arrangement, with reference to FIG. 1, during operation the analog matrix multiplier device 10 can retrieve a weighting matrix from which the second vector 30 can be selected. For example, in the case where the first vector 28 includes 784 row value coefficients representing the pixel values of the digital representation of the handwritten number 56, the analog matrix multiplier device 10 can retrieve a digital weighting matrix having ten columns, with each column including 784 column value coefficients 34. During operation, the analog matrix multiplier device 10 can sequentially select each column as the second vector 30 for further processing.

Returning to FIG. 4, in element 106, the set of digital-to-analog converters 11 of the analog matrix multiplier device 10 are configured to convert each of the row value coefficients 32 of the first vector 28 from a digital domain to an analog domain and to convert each of the column value coefficients 34 of the second vector 28 from the digital domain to the analog domain. For example, with reference to FIG. 1, during operation the analog matrix multiplier device 10 receives the first vector row 28 and the second vector column 30 having row and column value coefficients 32, 34 configured in the digital domain. In one arrangement, a first subset of digital-to-analog converters 12 is configured to convert the digital row value coefficients 32 into analog row value coefficients 36 and a second separate subset of digital-to-analog converters 13 is configured to convert the digital column value coefficients 34 into analog row value coefficients 38.

The analog matrix multiplier device 10 can include a variety of configurations of the digital-to-analog converters. In one arrangement, the analog matrix multiplier device 10 can be preconfigured with a separate digital-to-analog converter corresponding to each row and column value coefficients 32, 34. For example, the first subset of digital-to-analog converters 12 includes digital-to-analog converters 12-1 through 12-N which are configured to convert corresponding row and column value coefficients 32-1 through 32-N to the analog domain and the second subset of digital-to-analog converters 13 includes digital-to-analog converters 13-1 through 13-N which are configured to convert corresponding row and column value coefficients 34-1 through 34-N to the analog domain. Accordingly, in the case where the first vector 28 includes three row value coefficients 32 and the second vector 30 includes three column value coefficients 34, the analog matrix multiplier device 10 can utilize six separate digital-to-analog converters for the conversion of the coefficients 32, 34 into the analog domain.

In one arrangement, the analog matrix multiplier device 10 includes a fixed, preset number of digital-to-analog converters 11 configured to process the row and column value coefficients 32, 34 of the first and second vectors 28, 30 regardless of the number of coefficients. For example, the analog matrix multiplier device 10 can include eight digital-to-analog converters in the first subset of digital-to-analog converters 12 and eight digital-to-analog converters in the second subset of digital-to-analog converters 13. With such a configuration, when processing vectors 28, 30 having greater than eight row and column value coefficients 32, 34, the analog matrix multiplier device 10 can split the first vector 28 into its first eight row value coefficients 32, the second vector 30 into its first eight column value coefficients 34, covert the coefficients 32, 34 using the corresponding digital-to-analog converters 12, 13, ten move on to processing the next set of eight row value coefficients 32 and eight column value coefficients 34.

Returning to FIG. 4, in element 108, each signal generator 26-1 through 26-N of a set of signal generators 26 of the analog matrix multiplier device 10 is configured to generate a wave signal 27 at a given integer frequency. In one arrangement, with reference to FIG. 1, the set of signal generators 26 can be configured as sinusoidal wave oscillators 26 where each sinusoidal wave oscillator 26 is configured to generate a sine wave signal 27 at a given integer frequency. For example, sinusoidal wave oscillator 26-1 can generate a sine wave of 1 Hz, sinusoidal wave oscillator 26-2 through 26-N can generate a sine wave of 2 Hz, and sinusoidal wave oscillator 26-N can generate a sine wave of N Hz, corresponding to the number of row and column value coefficients 32, 34 in the respective first vector row 28 and second vector column 30. While the sinusoidal wave oscillators 26 are described as being configured to generate sine waves, the sinusoidal wave oscillators 26 can generate other types of waveforms as well, such as cosine waves.

Returning to FIG. 4, in element 110, the Fourier dot product circuit 15 of the analog matrix multiplier device 10 is configured to perform a Fourier dot product multiplication process relative to the row value coefficients 36 of the first vector 28, the column value coefficients 38 of the second vector 30, and corresponding wave signals 27 at given integer frequencies to generate a Fourier dot product 40. While the Fourier dot product circuit 15 can be configured to execute a Fourier dot product multiplication process in a variety of ways, with reference to FIG. 3, in one arrangement, the Fourier dot product circuit 15 can utilize the assembler stage 55 and the multiplier stage 57 to execute the process.

The assembler stage 55 of the Fourier dot product circuit 15 is configured to apply each analog row value coefficient 36 of the first vector to a corresponding sine wave signal 27 at a given integer frequency to generate a set of row-scaled sine wave signals 64 and to apply each analog column value coefficient 38 of the second vector to a corresponding sine wave signal 27 at a given integer frequency to generate a set of column-scaled sine wave signals 66. In one arrangement, the assembler stage 55 can utilize the set of frequency modulators 14 to scale each of the sine wave signals 27-1 through 27-N with each of the analog row value coefficients 36 of the first vector 28 and with each of the analog column value coefficients 38 of the second vector 30.

For example, the Fourier dot product circuit 15 can include a separate frequency modulator for each analog row value coefficient 36 of the first vector 28 and each analog column value coefficient 38 of the second vector. As such, the set of frequency modulators 14 can be subdivided into a first set of frequency modulators 60 having frequency modulators 60-1 through 60-N corresponding to digital-to-analog converters 12-1 through 12-N and a second set of frequency modulators 62-1 through 62-N corresponding to digital-to-analog converters 13-1 through 13-N.

During operation, each frequency modulator 60-1 through 60-N of the first set of frequency modulators 60 is configured to multiply each analog row value coefficient 36-1 through 36-N of the first vector 28 with the corresponding wave signal 27 at the given integer frequency to generate the set of row-scaled wave signals 64. For example, the frequency modulator 60-1 is configured to multiply analog row value coefficient 36-1 with sine wave signal 27-1 to generate row-scaled wave signal 64-1, analog row value coefficient 36-2 with sine wave signal 27-2 to generate row-scaled wave signal 64-2, and analog row value coefficient 36-N with sine wave signal 27-N to generate row-scaled wave signal 64-N. Further during operation, each frequency modulator 62-1 through 62-N of the second set of frequency modulators 60 is configured to multiply each analog column value coefficient 38-1 through 38-N of the second vector 30 with the corresponding wave signal 27 at the given integer frequency to generate the set of column-scaled wave signals 66. For example, the frequency modulator 62-1 is configured to multiply analog column value coefficient 38-1 with sine wave signal 27-1 to generate column-scaled wave signal 64-1, analog column value coefficient 38-2 with sine wave signal 27-2 to generate column-scaled wave signal 66-2, and analog column value coefficient 38-N with sine wave signal 27-N to generate column-scaled wave signal 66-N. As such, the set of frequency modulators 14 construct a set of sub-waves 64, 66 with amplitudes that correspond to the input coefficients 36, 38.

Next, with continued reference to FIG. 3, the assembler stage 55 is configured to sum each row-scaled sine wave signal 64-1 through 64-N of the set of row-scaled sine wave signals 64 to generate a first result 70 and to sum each column-scaled sine wave signal 66-1 through 66-N of the set of column-scaled sine wave signals 66 to generate a second result 72. In one arrangement, the assembler stage 55 can utilize a first summation amplifier 18-1 to add the row-scaled sine wave signals 64-1 through 64-N together to generated a first function f₁(x). as the first result 70. Additionally, the assembler stage 55 can utilize a second summation amplifier 18-2 to add the column-scaled sine wave signals 66-1 through 66-N together to generated a second function f₂(x). as the second result 72. As such, each of the first vector 28 and second vector 30 are encoded as sine series, f₁(x) and f₂(x), respectively.

Following execution of the assembler stage 55, Fourier dot product circuit 15 can utilize the multiplier stage 57 to generate the Fourier dot product 40. For example, the first and second summation amplifiers 18-1, 18-2 provide first and second results 70, 72, respectively, to the analog multiplier circuit 16 which is configured to multiply the first result 70 and the second result 72 to generate a product value 74, such as third function f₃(x). The analog multiplier circuit 16 provides the product value 74 to an integrator amplifier or circuit 20 which is configured to integrate the product value 74 to generate the Fourier dot product 40. The Fourier dot product 40 is configured as an analog voltage which is equivalent to the dot product of the first vector 28 and the second vector 30. In one arrangement, the integrator circuit 20 can integrate the product value between 0 and T where T=(2*pi)/omega to generate the Fourier dot product 40.

Returning to FIG. 4, in element 112 the analog-to-digital converter 22 of the analog matrix multiplier device 10 is configured to convert the Fourier dot product 40 from the analog domain to the digital domain and to output the Fourier dot product 42 in the digital domain. For example, with reference to FIG. 1, the Fourier dot product circuit 15 is configured to provide the analog Fourier dot product 40 to the analog to digital converter 22, which in turn, converts the analog Fourier dot product 40 to a digital Fourier dot product 42 and provides the digital Fourier dot product 40 to the computerized device 50. Upon receipt, the computerized device 50 can utilize the digital Fourier dot product 42 as part of the trained model 54, such as to classify the digital representation of a handwritten number 56 as an integer between 0-9, as in the present example. Further, the computerized device 50 can utilize the digital Fourier dot product 42 to go backwards through the trained model 54 in order to refine the various weighting factors of the model 54 to improve the model's accuracy.

In one arrangement, the analog matrix multiplier device 10 is configured to scale the analog Fourier dot product 40 prior to providing to the analog-to-digital converter 22. For example, with reference to FIG. 3, the analog multiplier device 10 can include a scaling amplifier 25 disposed in electrical communication with the Fourier dot product circuit 15 and the analog-to-digital converter 22. The scaling amplifier 25 is configured to receive the Fourier dot product 40 from the Fourier dot product circuit 15, scale the Fourier dot product 40 by a scaling factor, such as by a factor of 2/T, and provide the scaled Fourier dot product 44 to the analog-to-digital converter 22 for conversion to the digital domain

As provided above, the analog matrix multiplier device 10 includes an analog Fourier dot product circuit 15 configured to use a sine series to simplify dot product computations.

In one arrangement, the Fourier dot product analog multiplier device 10 reduces the number of transistor components needed to perform dot product multiplication relative to conventional accelerator devices. As the matrices increase in size, the number of analog components used by the Fourier dot product circuit 15 series increases linearly while the number of multipliers and integrators of conventional accelerators increases quadratically. For example, assume a conventional embedding table of 32000×2048 elements were to be multiplied by a Queries, Keys, and Values (QKV) matrix of 2048×64 to produce an output matrix of 32000×64. In the case where a conventional accelerator device performs such processing, the accelerator device would require approximately 4 billion digital multipliers (i.e., 32000 (rows)*64 (columns)*2048 (long dot products)) thereby requiring approximately 4 billion components. By contrast, in the case where the Fourier dot product analog multiplier device 10 performs such processing, the Fourier dot product analog multiplier device 10 would only utilize 68 million components (i.e., (32000 (rows)+64 (columns))*2048 (long dot products)=66 million oscillators and DACs at the front end of the device 10 plus 32000*64=2 million analog multipliers and integrators at the back end of the device 10. With such a reduction in the relative number of transistors utilized, the analog multiplier device 10 utilizes a relatively smaller circuit area and lower power compared to conventional accelerator devices.

Furthermore, the analog multiplier device 10 is configured to perform the dot product in one step while a digital system, sch s a conventional accelerator device, would need to compute the products, then add them. If there were N coefficients, a digital system would be required to perform N multiplies, followed by N additions which is a total of 2N steps which simplifies to order N. By contrast, the analog multiplier device 10 multiplies and adds the coefficients in the period of one wave, known as constant time or order 1. Accordingly, the analog matrix multiplier device 10 not only utilizes fewer components and power, it reduces the number of operations for an AI/ML model by however many components are present. For example, if an image 56 input into an AI/ML model has 1000 pixels, this circuit, with 1000 waves (i.e., 1000 modulators and 1 analog multiplier), can run 1000 times faster, comparatively.

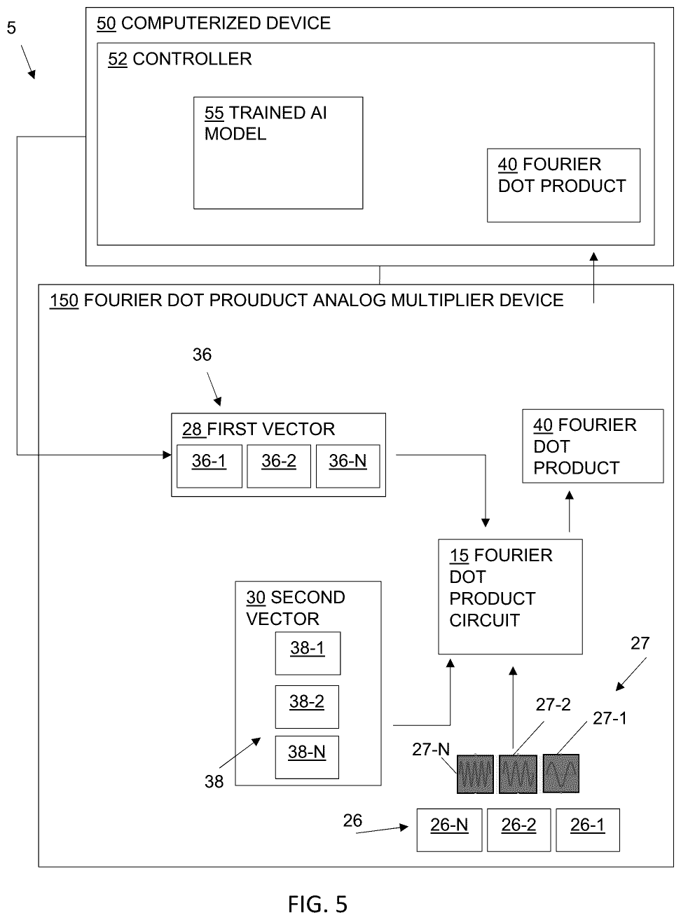

As provided above, the Fourier dot product analog matrix multiplier device 10 includes a set of digital to analog converters 11 and an analog to digital converters 22. Such a configuration can be utilized when the matrix multiplier device 10 is used in the digital domain, such as during machine learning processing. Such description is by way of example only. In one arrangement, as illustrated in FIG. 5, the analog matrix multiplier device 10 can be used in the analog domain, such as in an embedded AI use.

For example, as shown in FIG. 5, the computerized device 50 is configured to execute a trained AI model 55 and to offload matrix multiplication to a Fourier dot product analog matrix multiplier device 150. As indicated, during operation, the Fourier dot product circuit 150 receives a first vector 28 having matrix row value coefficients 36 in an analog domain and receives a second vector 30 having matrix column value coefficients 38 in the analog domain. The Fourier dot product circuit 15 perform a dot product multiplication process relative to the coefficients 36, 38 of the first and second vectors 28, 30 and corresponding wave signals at given integer frequencies, as described above. The Fourier dot product circuit 15 is further configured to output the resulting Fourier dot product 40 in the analog domain, such as to computerized device 50. Upon receipt, the computerized device 50 can utilize the Fourier dot product 40 as part of the trained model 55. Further, the computerized device 50 can utilize the Fourier dot product 40 to go backwards through the trained model 55, such as to refine the various weighting factors of the model 55 to improve the model's accuracy.

While various embodiments of the innovation have been particularly shown and described, it will be understood by those skilled in the art that various changes in form and details may be made therein without departing from the spirit and scope of the innovation as defined by the appended claims.

What is claimed is:

1. An analog matrix multiplier device, comprising:
a set of digital-to-analog converters configured to:
receive a first vector having matrix row value coefficients,
receive a second vector having matrix column value coefficients, and
convert each of the row value coefficients of the first vector from a digital domain to an analog domain and to convert each of the column value coefficients of the second vector from the digital domain to the analog domain;
a set of signal generators, each signal generator of the set of signal generators configured to generate a wave signal at a given integer frequency;
a Fourier dot product circuit disposed in electrical communication with the set of digital-to-analog converters and the set of signal generators, the Fourier dot product circuit configured to perform a Fourier dot product multiplication process relative to the row value coefficients of the first vector, the column value coefficients of the second vector, and corresponding wave signals at given integer frequencies to generate a Fourier dot product; and
an analog-to-digital converter disposed in electrical communication with the Fourier dot product circuit, the analog-to-digital converter configured to convert the Fourier dot product from the analog domain to the digital domain and to output the Fourier dot product in the digital domain.

2. The analog matrix multiplier device of claim 1, wherein the set of digital-to-analog converters comprises:
first set of digital-to-analog converters where each converter of the first set of digital-to-analog converters receives a corresponding row value coefficient of the first vector; and
a second set of digital-to-analog converters where each converter of the second set of digital-to-analog converters receives a corresponding column value coefficient of the second vector.

3. The analog matrix multiplier device of claim 1, wherein the set of signal generators comprises a set of sinusoidal wave oscillators, each sinusoidal wave oscillator of the set of sinusoidal wave oscillators configured to generate a sine wave signal at a given integer frequency.

4. The analog matrix multiplier device of claim 3, wherein the Fourier dot product circuit comprises an assembler stage disposed in electrical communication with the set of digital-to-analog converters and the set of sinusoidal wave oscillators, the assembler stage configured to:
apply each analog row value coefficient of the first vector to a corresponding sine wave signal at a given integer frequency to generate a set of row-scaled sine wave signals;
apply each analog column value coefficient of the second vector to a corresponding sine wave signal at a given integer frequency to generate a set of column-scaled sine wave signals;
sum each row-scaled sine wave signal of the set of row-scaled sine wave signals to generate a first result; and
sum each column-scaled sine wave signal of the set of column-scaled sine wave signals to generate a second result.

5. The analog matrix multiplier device of claim 4, wherein the assembler stage comprises:
a first set of frequency modulators, each frequency modulator of the first set of frequency modulators configured to multiply each analog row value coefficient of the first vector with the corresponding wave signal at the given integer frequency to generate the set of row-scaled wave signals;
a second set of frequency modulators, each frequency modulator of the second set of frequency modulators configured to multiply each analog column value coefficient of the second vector with the corresponding wave signal at the given integer frequency to generate the set of column-scaled wave signals;
a first summation amplifier configured to sum each row-scaled wave signal of the set of row-scaled wave signals to generate the first result; and
a second summation amplifier configured to sum each column-scaled wave signal of the set of column-scaled wave signals to generate the second result.

6. The analog matrix multiplier device of claim 4, wherein the Fourier dot product circuit further comprises a multiplier stage disposed in electrical communication with the assembler stage, the multiplier stage configured to:
generate a product value of the first result and the second result; and
integrate the product to generate the Fourier dot product.

7. The analog matrix multiplier device of claim 6, wherein the multiplier stage comprises:
an analog multiplier circuit configured to multiply the first result and the second result to generate the product value; and
an integrator circuit disposed in electrical communication with the analog multiplier circuit; the integrator circuit configured to integrate the product value to generate the Fourier dot product.

8. The analog matrix multiplier device of claim 1, further comprising a scaling amplifier disposed in electrical communication with the Fourier dot product circuit and the analog-to-digital converter, the scaling amplifier configured to:
receive the Fourier dot product from the Fourier dot product circuit;
scale the Fourier dot product by a scaling factor; and
provide the scaled Fourier dot product to the analog-to-digital converter.

9. In an analog matrix multiplier device, a method for generating a Fourier dot product, comprising:
receiving, by a set of digital-to-analog converters of the analog matrix multiplier device, a first vector having matrix row value coefficients;
receiving, by the set of digital-to-analog converters of the analog matrix multiplier device, a second vector having matrix column value coefficients;
converting, by the set of digital-to-analog converters of the analog matrix multiplier device, each of the row value coefficients of the first vector from a digital domain to an analog domain and to convert each of the column value coefficients of the second vector from the digital domain to the analog domain;
generating, by each signal generator of a set of signal generators of the analog matrix multiplier device, a wave signal at a given integer frequency;
performing, by a Fourier dot product circuit of the analog matrix multiplier device, a Fourier dot product multiplication process relative to the row value coefficients of the first vector, the column value coefficients of the second vector, and corresponding wave signals at given integer frequencies to generate a Fourier dot product; and
converting, by an analog-to-digital converter of the analog matrix multiplier device, the Fourier dot product from the analog domain to the digital domain and outputting the Fourier dot product in the digital domain.

10. The method of claim 9, wherein receiving the first vector having row value coefficients comprises:
receiving, by a first set of digital-to-analog converters, a corresponding row value coefficient of the first vector; and
receiving, by a second set of digital-to-analog converters, a corresponding column value coefficient of the second vector.

11. The method of claim 9, wherein generating the wave signal at a given integer frequency comprise generating, by each sinusoidal wave oscillator of a set of sinusoidal wave oscillators, a sine wave signal at a given integer frequency.

12. The method of claim 11, wherein performing the Fourier dot product multiplication process relative to the row value coefficients of the first vector, the column value coefficients of the second vector, and corresponding wave signals at given integer frequencies to generate the Fourier dot product comprises:
applying, by an assembler stage of the Fourier dot product circuit, each analog row value coefficient of the first vector to a corresponding sine wave signal at a given integer frequency to generate a set of row-scaled sine wave signals;
applying, by the assembler stage of the Fourier dot product circuit, each analog column value coefficient of the second vector to a corresponding sine wave signal at a given integer frequency to generate a set of column-scaled sine wave signals;
summing, by the assembler stage of the Fourier dot product circuit, each row-scaled sine wave signal of the set of row-scaled sine wave signals to generate a first result; and
summing, by the assembler stage of the Fourier dot product circuit, each column-scaled sine wave signal of the set of column-scaled sine wave signals to generate a second result.

13. The method of claim 12, wherein:
applying each analog row value coefficient of the first vector to the corresponding wave signal at a given integer frequency to generate the set of row-scaled wave signals comprises multiplying, by each frequency modulator of a first set of frequency modulators, each analog row value coefficient of the first vector with the corresponding wave signal at the given integer frequency to generate the set of row-scaled wave signals;
applying each analog column value coefficient of the second vector to the corresponding wave signal at a given integer frequency to generate the set of column-scaled wave signals comprises multiplying, by each frequency modulator of a second set of frequency modulators, each analog column value coefficient of the second vector with the corresponding wave signal at the given integer frequency to generate the set of column-scaled wave signals;
summing each row-scaled wave signal of the set of row-scaled wave signals to generate the first result comprises summing, by a first summation amplifier, each row-scaled wave signal of the set of row-scaled wave signals to generate the first result; and
summing each column-scaled wave signal of the set of column-scaled wave signals to generate the second result comprises summing, by a second summation amplifier, each column-scaled wave signal of the set of column-scaled wave signals to generate the second result.

14. The method of claim 12, further comprising disposed in electrical communication with the assembler stage, the multiplier stage configured to:
generating, by a multiplier stage, a product value of the first result and the second result; and
integrating, by the multiplier stage, the product to generate the Fourier dot product.

15. The method of claim 12, wherein
generating the product value of the first result and the second result comprises multiplying, by an analog multiplier circuit, the first result and the second result to generate the product value; and
integrating the product to generate the Fourier dot product comprises integrating, by an integrator circuit, the product value to generate the Fourier dot product.

16. The method of claim 9, further comprising:
receiving, by a scaling amplifier, the Fourier dot product from the Fourier dot product circuit;
scaling, by the scaling amplifier, the Fourier dot product by a scaling factor; and
providing, by the scaling amplifier, the scaled Fourier dot product to the analog-to-digital converter.

17. An analog matrix multiplier device, comprising:
a set of signal generators, each signal generator of the set of signal generators configured to generate a wave signal at a given integer frequency;
a Fourier dot product circuit disposed in electrical communication with the set of signal generators, the Fourier dot product circuit configured to:
receive a first vector having matrix row value coefficients in an analog domain,
receive a second vector having matrix column value coefficients in the analog domain,
perform a Fourier dot product multiplication process relative to the row value coefficients of the first vector, the column value coefficients of the second vector, and corresponding wave signals at given integer frequencies to generate a Fourier dot product, and
output the Fourier dot product in the analog domain.

18. The analog matrix multiplier device of claim 17, wherein the set of signal generators comprises a set of sinusoidal wave oscillators, each sinusoidal wave oscillator of the set of sinusoidal wave oscillators configured to generate a sine wave signal at a given integer frequency.

19. The analog matrix multiplier device of claim 18, wherein the Fourier dot product circuit comprises an assembler stage disposed in electrical communication with the set of signal generators, the assembler stage configured to:
apply each analog row value coefficient of the first vector to a corresponding sine wave signal at a given integer frequency to generate a set of row-scaled sine wave signals;
apply each analog column value coefficient of the second vector to a corresponding sine wave signal at a given integer frequency to generate a set of column-scaled sine wave signals;
sum each row-scaled sine wave signal of the set of row-scaled sine wave signals to generate a first result; and
sum each column-scaled sine wave signal of the set of column-scaled sine wave signals to generate a second result.

20. The analog matrix multiplier device of claim 19, wherein the assembler stage comprises:
a first set of frequency modulators, each frequency modulator of the first set of frequency modulators configured to multiply each analog row value coefficient of the first vector with the corresponding wave signal at the given integer frequency to generate the set of row-scaled wave signals;
a second set of frequency modulators, each frequency modulator of the second set of frequency modulators configured to multiply each analog column value coefficient of the second vector with the corresponding wave signal at the given integer frequency to generate the set of column-scaled wave signals;
a first summation amplifier configured to sum each row-scaled wave signal of the set of row-scaled wave signals to generate the first result; and
a second summation amplifier configured to sum each column-scaled wave signal of the set of column-scaled wave signals to generate the second result.

21. The analog matrix multiplier device of claim 19, wherein the Fourier dot product circuit further comprises a multiplier stage disposed in electrical communication with the assembler stage, the multiplier stage configured to:
generate a product value of the first result and the second result; and
integrate the product to generate the Fourier dot product.

22. The analog matrix multiplier device of claim 21, wherein the multiplier stage comprises:
an analog multiplier circuit configured to multiply the first result and the second result to generate the product value; and
an integrator circuit disposed in electrical communication with the analog multiplier circuit; the integrator circuit configured to integrate the product value to generate the Fourier dot product.

23. In an analog matrix multiplier device, a method for generating a Fourier dot product, comprising:
receiving, by a Fourier dot product circuit of the analog matrix multiplier device, a first vector having matrix row value coefficients in an analog domain;
receiving, by the Fourier dot product circuit of the analog matrix multiplier device, a second vector having matrix column value coefficients in the analog domain;
generating, by each signal generator of a set of signal generators of the analog matrix multiplier device, a wave signal at a given integer frequency;
performing, by the Fourier dot product circuit of the analog matrix multiplier device, a Fourier dot product multiplication process relative to the row value coefficients of the first vector, the column value coefficients of the second vector, and corresponding wave signals at given integer frequencies to generate a Fourier dot product; and
outputting, by the Fourier dot product circuit of the analog matrix multiplier device, the Fourier dot product in the analog domain.
